(19) United States
(12) Patent Application Publication
(10) Pub. No.: US 2009/0040056 A1
(43) Pub. Date: Feb. 12, 2009

(54) RECEPTACLE CAPABLE OF WARNING OVERLOADING

(76) Inventor: PANG-PIAO YANG, KAOHSIUNG (TW)

Correspondence Address: G. LINK CO., LTD., 3550 BELL ROAD, MINOOKA, IL, 60447, US

(21) Appl. No.: 12/185,027

(22) Filed: Aug. 1, 2008

(30) Foreign Application Priority Data
Aug. 8, 2007 (TW) 096212996

(51) Int. Cl. G08B 17/06

(52) U.S. Cl. 340/595

(57) ABSTRACT

A receptacle capable of warning overloading includes a receptacle main body and a protect device. The receptacle main body transmits a power source to an electric product while a plug of said electric product being inserted to the receptacle main body. The protect device is attached to the receptacle main body. It is characterized in that the protect device further comprises a detect circuit for detecting an amperage, and a warning component for receiving a signal coming from said detect circuit and converting the signal to a warning sound, a warning flash light or a numerical value. Thus, when the output end of the receptacle has an abnormal current overload, the user is notified to be aware of the problem of overloading.

### BACKGROUND OF THE INVENTION

1. Field of the Invention

The present invention is related to a receptacle capable of warning overloading and particularly to a receptacle capable of transmitting a signal to form a warning to notify the user at the time of the output end appearing abnormal overload current.

2. Brief Description of the Related Art

The conventional receptacle such as the receptacle with an extension line, the three-way receptacle or the receptacle attached to a wall provides a plurality of sockets available for being inserted with the plugs of different electric devices before the electric devices are turned on. It is known that the conventional receptacle is employed as a trunking connection for the power transmission without provision of safety device. However, it is easy to burn out the conventional receptacle due to the exceeding current load and, more seriously, a fire accident may happen to cause a disaster.

In order to overcome the preceding shortcoming, a conductive plate assembly has been applied to connect with the power supply end. The conductive plate assembly includes two metal plates in different expansion coefficients. The two metal plates deform and separate from each other due to different expansion coefficients when the conductive plate assembly is subjected to the heat (i.e. the current load) such that the power source via the receptacle becomes in an open circuit to play a role of overload protection. Although the preceding prior art has been disclosed by many patent references and applied in various electric products, it still has a deficiency, that is, the two metal plates restore the original shapes thereof after they cool down and the problem of the overload is still not solved. Hence, the conductive plate assembly keeps the operations of open circuit and close circuit repeatedly to damage the electric devices. More over, if the user is not aware of the problem of overloading and keeps using the receptacle or adding new electric devices, an unpredictable accident may occur.

### SUMMARY OF THE INVENTION

An object of the present invention is to provide a receptacle capable of warning overloading, which includes a receptacle main body and a protect device. The receptacle main body transmits a power source to an electric product while a plug of said electric product being inserted to the receptacle main body. The protect device is attached to the receptacle main body. It is characterized in that the protect device further comprises a detect circuit for detecting an amperage, and a warning component for receiving a signal coming from said detect circuit and converting said signal to a warning sound, a warning flash light or a numerical value.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of a receptacle with warning of overload according to the present invention; and

FIG. 2 is a plan view of the receptacle shown in FIG. 1.

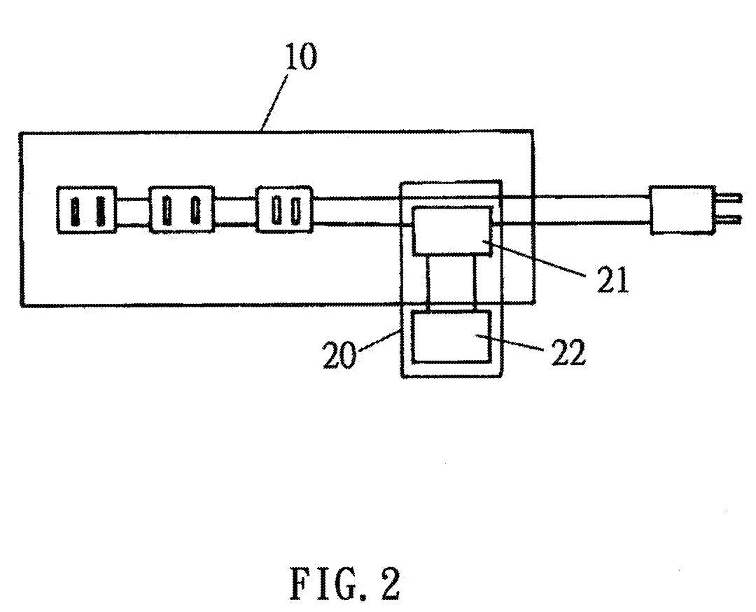

### DETAILED DESCRIPTION OF THE INVENTION

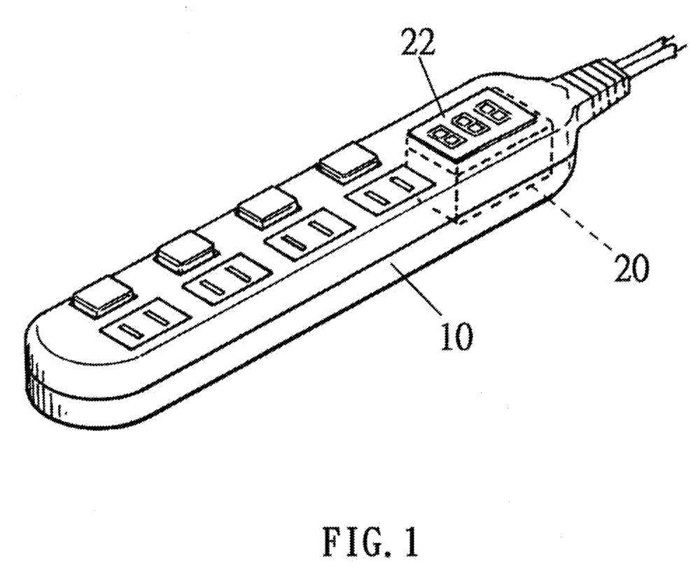

Referring to FIG. 1, a receptacle capable of warning overload according to the present invention includes a receptacle body 10 and a protect device 20. The receptacle body 10 is referred to a socket for a plug such that the power can be supplied to an electric product while the electric product is turned on. Especially, the receptacle body 10 is referred to a receptacle with an extension wire, a three-direction receptacle or a receptacle attached to a wall.

The protect device 20 includes a detect circuit 21 for detecting the amperage and a warning component 22 for receiving signals issued by the detect circuit 21 and converting the signals to a warning sound, warning light or a warning numerical value. For instance, the warning component 22 can be a buzzer, a light emit diode (LED) or an amperage indicator (a dial type or a digital type).

When the receptacle of the present invention is in use, the receptacle main body 10 can output the normal power source and the protect device 20 can detect the amperage of the output power via the receptacle main body 10 additionally. Once the amperage of the output power exceeds a safety reference value of the detect circuit 21 and an abnormal overload appears, the detect circuit 21 emits a signal to notify the warning component 22 and the warning component 22 issues a sound, a light flashing, a numerical value or a combination of the sound, the light flashing and/or the numerical value to warn the user that the power is overloading for securing the safety of the household.

Besides, the receptacle main body 10 of the receptacle capable of warning overload according to the present invention can provides a shape of three-way type, wall attaching type or ground attaching type in addition to the extension line type shown in FIG. 1 to perform the same.

While the invention has been described with referencing to preferred embodiments thereof, it is to be understood that modifications or variations may be easily made without departing from the spirit of this invention, which is defined by the appended claims.

What is claimed is:

1. A receptacle capable of warning overloading comprising:
a receptacle main body for transmitting a power source to an electric product while a plug of said electric product being inserted to said receptacle main body; and
a protect device attached to said receptacle main body;
characterized in that said protect device further comprises a detect circuit for detecting an amperage, and a warning component for receiving a signal coming from said detect circuit and converting said signal to a warning sound, a warning flash light or a numerical value.

2. The receptacle defined in claim 1, wherein said warning component is a buzzer.

3. The receptacle defined in claim 1, wherein said warning component is a LED device.

4. The receptacle defined in claim 1, wherein said warning component is an amperage indicator.
